(19) United States
(12) Patent Application Publication
(10) Pub. No.: US 2024/0410565 A1
(43) Pub. Date: Dec. 12, 2024

(54) EASY-TO-ASSEMBLY COMBINED FAN

(71) Applicant: SHENZHEN DI MENG TECHNOLOGY CO., LTD, SHENZHEN CITY (CN)

(72) Inventor: WEI LIU, SHENZHEN CITY (CN)

(21) Appl. No.: 18/798,170

(22) Filed: Aug. 8, 2024

(30) Foreign Application Priority Data
Jun. 9, 2023 (CN) 202321476026.4

(51) Int. Cl. F21V 33/00; F04D 29/52; F21V 19/00; F21Y 103/10; F21Y 113/00; F21Y 115/10

(52) U.S. Cl. CPC F21V 33/0096; F04D 29/522; F21V 19/0025; F21Y 2103/10; F21Y 2113/00; F21Y 2115/10

(57) ABSTRACT

An easy-to-assembly combined fan, includes a frame and a light strip. The light strip is arranged inside an annular limit groove inside the frame. Light bulbs, a first electrode, and a second electrode are integrated at a circuit board of the light strip. The circuit board constitutes a light board of the fan, and the first electrode and the second electrode constitute two interfaces of the fan. The integration arrangement of the light board and the interface facilitates fan assembly.

### CROSS-REFERENCE TO RELATED PATENT APPLICATION

This application claims priority to Chinese Patent Application No. 202321476026.4, filed on Jun. 9, 2023, the content of all of which is incorporated herein by reference.

### FIELD OF THE DISCLOSURE

The present disclosure relates to the technical field of computer fans, in particular to an easy-to-assembly combined fan.

### BACKGROUND OF THE DISCLOSURE

Computer fans are mainly used for cooling heating components inside a computer case. With the development of CPU (Central Processing Unit) and graphics card technology, the cooling requirements for fans are rising. Thus, combining multiple fans can significantly enhance cooling effects.

However, to improve lighting effects, the current computer fans generally include a built-in light board for lighting a fan frame. When multiple such fans are combined, their structures are assembled and their circuits are assembled. The existing combined fans generally adopt a connection module to achieve the combination of fans, and a fan interface needs to be arranged with a clamping position or a cable to be welded to the light board, making assembly more complex. When the connection module is repeatedly plugged in and out, it can easily cause the interface to loosen or a welding position to rupture, affecting circuit stability.

The term “assembly” in the present disclosure refers to that a light board, an interface, a frame, etc. are assembled to form a fan. The term “combine” in the present disclosure refers to that two or more fans are integrally combined together.

### SUMMARY OF THE DISCLOSURE

In a first aspect, the present disclosure provides an easy-to-assembly combined fan, aiming to facilitate the assembly of the combined fan by the integration of a light board and an interface, and make the fan combination operations simple and convenient by improving the combination structure.

In a second aspect, the present disclosure provides an easy-to-assembly combined fan structure, aiming to facilitate the assembly of the combined fan by the integration of the light board and the interface, and effectively lower the fan production costs by reducing the use of cables.

The easy-to-assembly combined fan provided by the present disclosure includes:
a frame, including a first combination end and a second combination end, where an annular limit groove surrounding fan blades is arranged inside the frame, the first combination end is arranged with a mortise and tenon structure and a through hole communicating inside and outside of the annular limit groove, and the second combination end is arranged with a mortise and tenon structure and a through hole communicating the inside and outside of the annular limit groove; and
a light strip, including a circuit board, where the circuit board is integrated with light bulbs, a first electrode, and a second electrode, the light strip is arranged inside the annular limit groove, the first electrode corresponds to the through hole of the first combination end, and the second electrode corresponds to the through hole of the second combination end.

In the present combined fan, the light bulbs, the first electrode, and the second electrode are integrated at the circuit board, where the circuit board constitutes a light board of the fan, and the first electrode and the second electrode constitute two interfaces of the fan. During actual assembly, the circuit board is directly clamped into the annular limit groove inside the frame to complete the assembly, so that the assembly steps are simple.

When combining two fans, the combination is completed only by attaching the first combination end of one fan to the second combination end of the other fan, and combining the mortise and tenon structures of the combination ends, where no tools are required during the combination, so that the combination steps are simple and convenient.

The easy-to-assembly combined fan structure provided by the present disclosure includes:
a frame, including an upper housing and a lower housing, where the upper housing and the lower housing enclose an annular limit groove;
a light strip, arranged inside the annular limit groove, where the light strip includes a PCB and light bulbs, the light bulbs are arranged at the PCB with intervals, and the PCB is arranged with a transition portion cooperating with a bent end of the frame; and
an electrical connection part, welded on the PCB, where the electrical connection part is exposed to at least one combination surface of an outer wall of the frame.

In actual design, the light bulbs and the electrical connection part are integrally welded and fixed on the PCB, so that a series connection of the light strips on four wall surfaces of the frame is realized, and the combination of the frame is convenient. In actual installation, the PCB is directly clamped between the upper housing and the lower housing to complete the assembly, so that the assembly steps are simple, and the service life of the electrical connection part is more stable.

### BRIEF DESCRIPTION OF THE DRAWINGS

FIG. 1 is a schematic diagram of a fan in Embodiment 1.

FIG. 2 is a cross-sectional view of the fan in Embodiment 1.

FIG. 3 is a schematic diagram of a first combination end.

FIG. 4 is a schematic diagram of a second combination end.

FIG. 5 is a schematic diagram of a light strip.

FIG. 6 is an enlarged view of portion B in FIG. 2.

FIG. 7 is an enlarged view of portion A in FIG. 2.

FIG. 8 is a schematic diagram of a tenon.

FIG. 9 is a schematic diagram of two fans combined together.

FIG. 10 is a schematic diagram of a fan in Embodiment 2.

FIG. 11 is a schematic diagram of a fan in Embodiment 3.

FIG. 12 is a cross-sectional view of the fan in Embodiment 3.

FIG. 13 is a schematic diagram of a combined fan structure after an upper housing is hidden.

FIG. 14 is a schematic diagram of a light strip.

### DETAILED DESCRIPTION OF THE EXEMPLARY EMBODIMENTS

The technical solutions in the embodiments of the present disclosure are clearly and completely described below in conjunction with the accompanying drawings. Obviously, the described embodiments herein are only one part of the embodiments of the present disclosure, and not all of the embodiments. Based on the embodiments of the present disclosure, all other embodiments obtained by those ordinary skilled in the art without creative labor are within the protection scope of the present disclosure.

It should be noted that directional indications in the embodiments of the present disclosure (such as up, down, left, right, front, rear, back, top, bottom, inner, inside, outer, outside, perpendicular, transverse, longitudinal, counterclockwise, clockwise, circumferential, radial, axial, etc.) are only used to explain the relative-position relationship, moving state, etc. of various components at a specific posture (as shown in the attached drawings). If the specific posture changes, the directional indications change accordingly.

In addition, descriptions (such as “first”, “second”, etc.) in the embodiments of the present disclosure are only for descriptive purposes and cannot be understood as indicating or implying the relative importance or implying the number of technical features indicated. Therefore, features limited to “first”, “second”, etc. may explicitly or implicitly include at least one of these features. In addition, the technical solutions of various embodiments may be combined with each other, but must be based on that those ordinary skilled in the art can implement the combination of technical solutions. When the combination of technical solutions is contradictory or impossible to implement, it should be understood that the combination of technical solutions does not exist and is not within the protection scope of the present disclosure.

### Embodiment 1

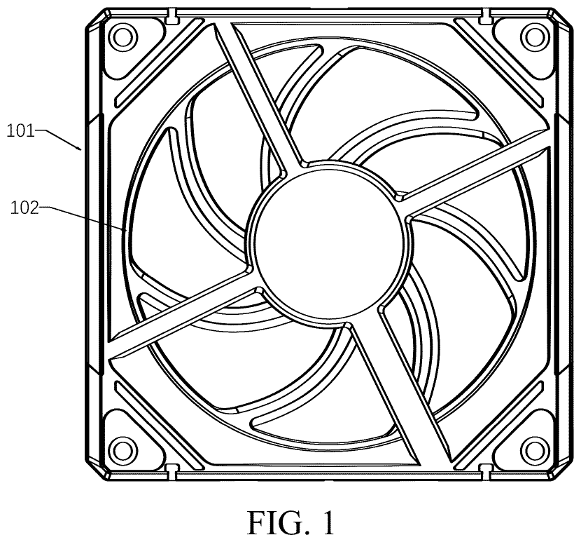

Referring to FIG. 1, a fan in Embodiment 1 includes fan blades 102, a frame 101, and a light strip. The fan blades 102 are installed at a center of the frame 101 and can rotate under the drive of a motor. The light strip (not shown in FIG. 1) is arranged inside the frame 101.

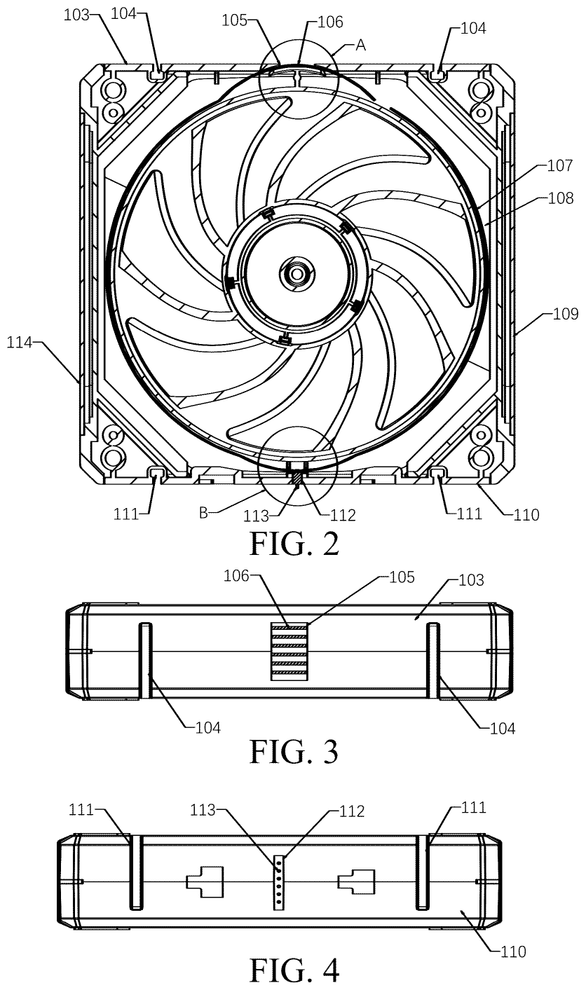

Referring to FIG. 2, an upper end 103 of the frame is a first combination end, a lower end 110 of the frame is a second combination end, and both a left end 114 of the frame and a right end 109 of the frame are light-output ends. An outer contour of a front end of the frame is substantially square, and outer contours of upper, lower, left, and right ends of the frame are substantially rectangular. An annular limit groove 108 is arranged inside the frame 101, and the annular limit groove surrounds the fan blades.

Referring to FIGS. 2 and 3, a first hole 105 is arranged at a middle part of the upper end 103 of the frame, and the first hole 105 communicates inside and outside of the annular limit groove 108. The upper end 103 is arranged with one first mortise 104 located at a left side of the first hole 105, and arranged with another first mortise 104 located at a right side of the first hole 105. The first mortise 104 extends along a short side of the upper end 103. The upper end 103 of the frame constitutes a first combination end, the first mortise 104 constitutes a mortise and tenon structure of the first combination end, and the first hole 105 constitutes a through hole of the first combination end, where the through hole communicates the inside and outside of the annular limit groove 108.

Referring to FIGS. 2 and 4, a second hole 112 is arranged at a middle part of the lower end 110 of the frame, and the second hole 112 communicates the inside and outside of the annular limit groove 108. The lower end 110 is arranged with one second mortise 111 located at a left side of the second hole 112, and arranged with another second mortise 111 located at a right side of the second hole 112. The second mortise 111 extends along a short side of the lower end 111. The lower end 110 of the frame constitutes a second combination end, the second mortise 111 constitutes a mortise and tenon structure of the second combination end, and the second hole 110 constitutes a through hole of the second combination end, where the through hole communicates the inside and outside of the annular limit groove 108.

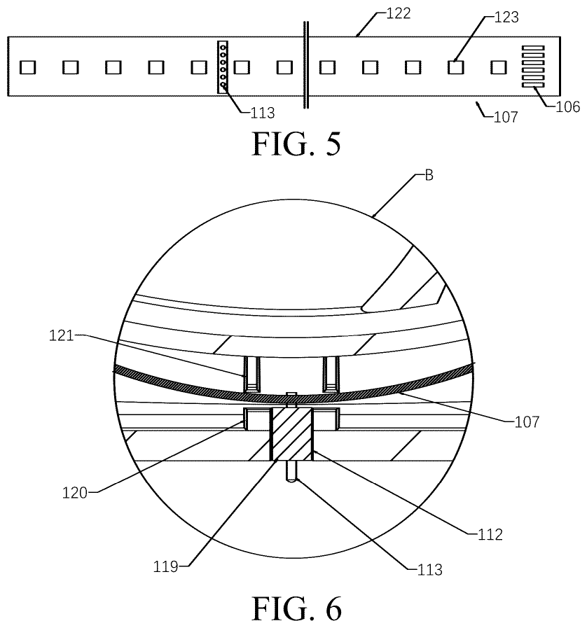

Referring to FIG. 5, the light strip 107 includes a circuit board 122. A front surface of the circuit board 122 is welded with a plurality of LED (light-emitting diode) light bulbs 123, and the light bulbs 123 are set with intervals. The front surface of the circuit board 122 is further integrated with a first electrode 106 and a second electrode 113. In this embodiment, the first electrode 106 is a metal film on a surface of the circuit board, and the shape of the first electrode 106 is a slender rectangle. The shape of the first electrode 106 may also be circular, square, or other shapes. This embodiment does not limit the shape of the first electrode 106. The second electrode 113 is a conductive needle. One end of the conductive needle is welded on the circuit board 122. The conductive needle is perpendicular to the front surface of the circuit board 122. The conductive needle may be an elastic conductive needle. The number of the first electrodes 106 is the same as the number of the second electrodes 113, where the specific number can be set according to actual needs and this embodiment does not limit the number of electrodes. The circuit board 122 is a strip-shaped structure and is bendable.

Referring to FIG. 2, the light strip 107 is clamped into the annular limit groove 108 inside the frame, the first electrode 106 of the light strip 107 corresponds to the first hole 105 of the upper end 103 of the frame, and the second electrode 113 of the light strip 107 corresponds to the second hole 112 of the lower end 110 of the frame. The first electrode 106 is substantially flush with the upper end 103 of the frame, and the second electrode 113 is exposed from the lower end 110 of the frame.

In this embodiment, the light bulbs 123, the first electrode 106, and the second electrode 113 are all integrated at the circuit board 122, where the circuit board 122 constitutes a light board of fan, and the first electrode 106 and the second electrode 113 constitute two interfaces of fan. During actual assembly, the circuit board 122 is directly clamped into the annular limit groove 108 in the frame to complete the assembly, so that the assembly steps are simple.

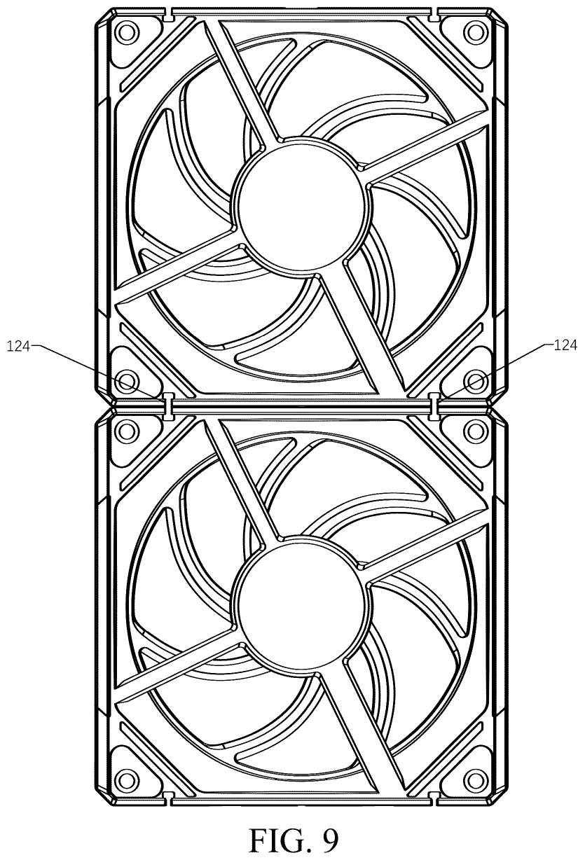

Two fans can be combined together by using a tenon cooperating with the mortise. FIG. 8 schematically shows a structure of the tenon 124 and FIG. 9 shows a state of the combined two fans.

When the two fans are combined, the first combination end of one fan is attached to the second combination end of the other fan, so that the electrodes of the combination ends are aligned with each other, and the mortises are aligned with each other; then the tenon 124 is aligned with an entrance of the mortise and then inserted into the mortise to complete the combination of the two fans, so that the combination steps are simple and no tools are required during the combination.

Referring to FIGS. 2, 4, and 6, in this embodiment, the second electrode 113 is a conductive needle, and a body of the conductive needle is arranged with an insulating base 119. When the light strip 107 is clamped to the annular limit groove 108 inside the frame, the insulating base 119 is embedded into the second hole 112 of the lower end 110 of the frame to position the conductive needle, thereby preventing the conductive needle from displacing in a left direction, a right direction, a front direction, and a rear direction in FIG. 6. Thus, when two fans are combined, the conductive needle does not shake, and the electrical connection between the two fans is more reliable. The lower end 110 of the frame is the second combination end, the left direction and right direction in FIG. 6 are extension directions of a long side of the second combination end, and the front direction and rear direction in FIG. 6 are extension directions of a short side of the second combination end.

Referring to FIGS. 2 and 6, a first protrusion 120 and a second protrusion 121 both facing the light strip 107 are arranged at a periphery inside the annular limit groove 108 corresponding to the second hole 112. The first protrusion 120 abuts against the front surface of the circuit board of the light strip 107, and the second protrusion 121 abuts against a back surface of the circuit board of the light strip 107. The first protrusion 120 and the second protrusion 121 are configured to clamp the circuit board of the light strip 107. Thus, when two fans are combined and the second electrode 113 is pressed upward by the first electrode 106 of the other fan, the circuit board of the light strip 107 does not deform upward, so that the electrical connection between the two fans is more reliable. The second hole 112 is a through hole of the second combination end, and the through hole communicating the inside and outside of the annular limit groove 108.

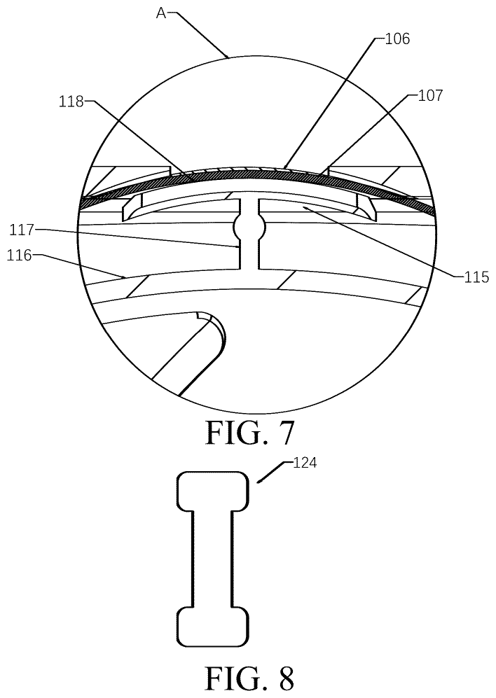

Referring to FIGS. 2 and 7, a third protrusion 115 facing the circuit board of the light strip 107 is arranged inside the annular limit groove 108 corresponding to the first electrode 106. The third protrusion 115 abuts against a back surface of the circuit board of the light strip 107 to form an upward support effect on the first electrode 106 of the light strip 107. Thus, when two fans are combined and the first electrode 106 is pressed downward by the second electrode 113 of the other fan, the first electrode 106 is not displaced or deformed downward, so that the electrical connection between the two fans is more reliable.

Referring to FIG. 7, in this embodiment, the third protrusion 115 includes a plate-shaped portion 118 and a rib portion 117, where the plate-shaped portion 118 is attached on the back surface of the circuit board of the light strip 107, and the rib portion 117 is connected between a back surface of the plate-shaped portion 118 and a groove wall 116 of the annular limit groove 108. The plate-shaped portion 118 can form a large area of contact with the circuit board of the light strip 107, so that the upward support effect on the first electrode 106 of the light strip 107 is better. A middle part of the plate-shaped portion 118 arches upward with respect to both a left-end part and a right-end part of the plate-shaped portion 118, and is in a convex-arc shape.

Referring to FIG. 2, in Embodiment 1, the upper end 103 of the frame is a first combination end, the lower end 110 of the frame is a second combination end, and the first combination end and the second combination end are parallel. Multiple fans can be combined together in a up and down direction.

In some other embodiments, two adjacent ends of the frame may be set as combination ends of fan. For example, the left end 114 of the frame is set as the first combination end, and the lower end 110 or the upper end 103 of the frame is set as the second combination end.

In this embodiment, the mortise and tenon structure of the first combination end and the mortise and tenon structure of the second combination end are both mortises, an advantage thereof is that the mortise and tenon structures do not protrude from the first combination end or the second combination end, and when the fan is used independently, the mortise and tenon structures do not interfere with an installation environment. A disadvantage of this embodiment is that the tenon 124 is an accessory, i.e. the tenon 124 is only used for combination, and the tenon 124 needs to be stored separately before combination.

In some other embodiments, the mortise and tenon structure of the first combination end is selected from one of a mortise and a tenon, and the mortise and tenon structure of the second combination end is selected from the other one of the mortise and the tenon, where the following Embodiment 2 is an example.

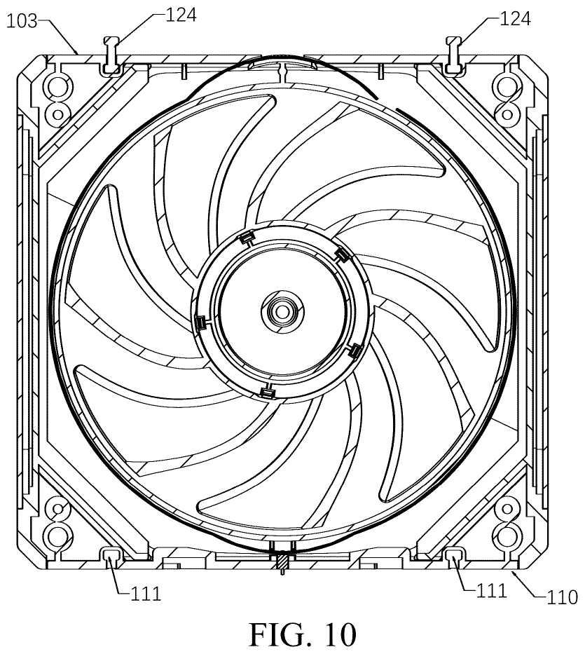

FIG. 10 shows a fan of Embodiment 2. Referring to FIG. 10, in Embodiment 2, the upper end 103 of the frame is a first combination end, the lower end 110 of the frame is a second combination end, the mortise and tenon structure of the upper end 103 is a tenon 124, and the mortise and tenon structure of the lower end 110 is a second mortise 111. In this embodiment, when two fans are combined, the combination is completed by aligning the tenon 124 of one fan with an entrance of the second mortise 111 of the other fan, and inserting the tenon 124 into the second mortise 111. In this embodiment, the tenon 124 is fixed to the frame and does not need to be stored separately.

Others details are the same as those in Embodiment 1 and are not repeated here.

### Embodiment 3

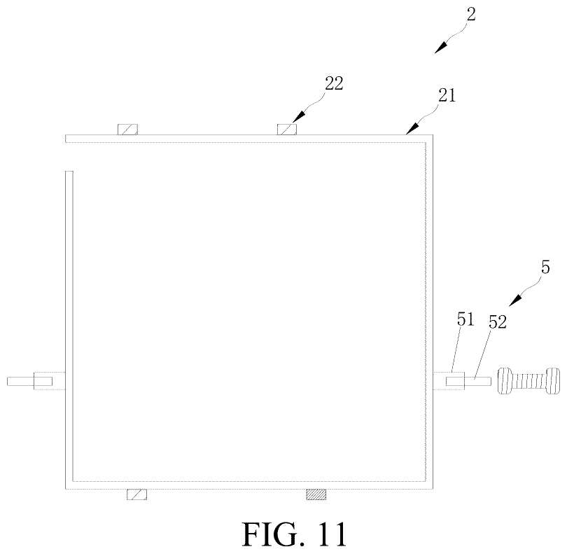

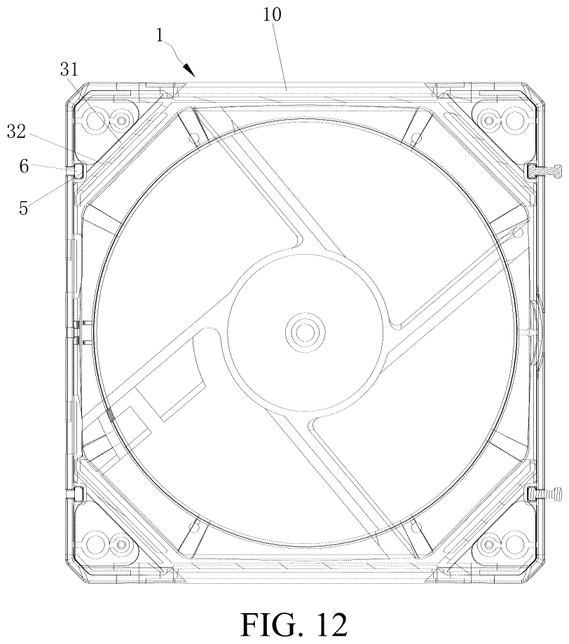

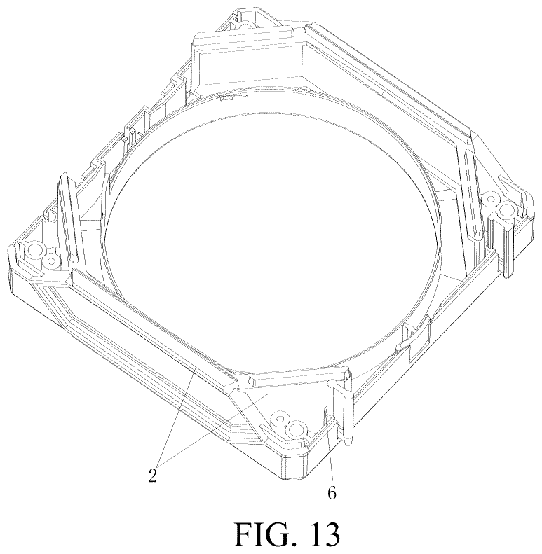

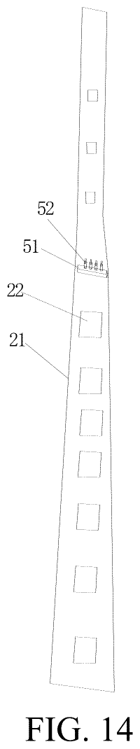

Referring to FIGS. 11 to 14, a combination fan structure in Embodiment 3 includes:
a frame 1, where the frame 1 includes an upper housing and a lower housing, and the upper housing and the lower housing enclose an annular limit groove 10;
a light strip 2, where the light strip 2 is arranged inside the annular limit groove 10, the light strip 2 includes a PCB (Printed Circuit Board) 21 and light bulbs 22, the light bulbs 22 are arranged at the PCB 21 with intervals, and the PCB 21 is arranged with a transition portion 32 matching a bent end 31 of the frame 1; and
an electrical connection part 5, where the electrical connection part 5 is welded on the PCB 21, and the electrical connection part 5 is exposed from at least one combination surface 4 of an outer wall of the frame 1.

In actual design, the light bulbs 22 and the electrical connection part 5 are integrally welded and fixed on the PCB 21, so that a series connection of the light strips 2 on four wall surfaces of the frame 1 is realized, and the combination of the frame 1 is convenient. In actual installation, the PCB 21 is directly clamped between the upper housing and the lower housing to complete the assembly, so that the assembly steps are simple, and the service life of the electrical connection part 5 is more stable.

In some embodiments, the PCB 21 is a flexible PCB 21, which can be deformed and bent according to the shape of the annular limit groove 10. The flexible PCB is a highly reliable and excellent flexible printed circuit board made of a polyimide or polyester film as a base material. The flexible PCB has the characteristics of high wiring density, small weight, small thickness and good bending property. In some embodiments, the transition portion 32 may be a cable.

In some embodiments, the bent end 31 is arranged at a 45-degree inclination, so that the flexible PCB is formed in a non-right-angled state, thereby avoiding damage caused by folding the flexible PCB.

In this embodiment, the electrical connection part 5 includes an insulating boss 51 and an electrode portion 52 arranged at the insulating boss 51. The frame 1 is arranged with a clamp groove to cooperate with the insulating boss 51, so as to clamp the electrode portion 52.

Furthermore, the electrical connection part 5 is arranged at a position of the transition portion 32, thereby reducing light-device influences and improving lighting effects.

In this embodiment, the electrode portion 52 is an electrode sheet or an elastic center.

In some embodiments, the frame 1 is arranged with a clamp groove 6 cooperating with the insulating boss 51.

In this embodiment, the clamp groove 6 is in a T-shape.

The present disclosure is described above in detail through specific embodiments. These detailed description is only limited to help those skilled in the art understand the contents of the present disclosure and cannot be understood as a limitation on the protection scope of the present disclosure. Any various modification, equivalent transformation, etc. made by those skilled in the art under the spirit of the present disclosure, should be included in the protection scope of the present disclosure.

What is claimed is:

1. An easy-to-assembly combined fan, comprising:
a frame, comprising a first combination end and a second combination end, wherein an annular limit groove surrounding fan blades is arranged inside the frame, the first combination end is arranged with a mortise and tenon structure and a through hole communicating inside and outside of the annular limit groove, and the second combination end is arranged with a mortise and tenon structure and a through hole communicating the inside and outside of the annular limit groove; and
a light strip, comprising a circuit board, wherein the circuit board is integrated with light bulbs, a first electrode, and a second electrode, the light strip is arranged inside the annular limit groove, the first electrode corresponds to the through hole of the first combination end, and the second electrode corresponds to the through hole of the second combination end.

2. The easy-to-assembly combined fan according to claim 1, wherein the mortise and tenon structure of the first combination end is one of a mortise and a tenon, and the mortise and tenon structure of the second combination end is the other one of the mortise and the tenon.

3. The easy-to-assembly combined fan according to claim 1, wherein the mortise and tenon structure of the first combination end and the mortise and tenon structure of the second combination end are mortises.

4. The easy-to-assembly combined fan according to claim 1, wherein the first electrode is a metal film on a surface of the circuit board, the second electrode is a conductive needle, one end of the conductive needle is welded to the circuit board, and the conductive needle is arranged perpendicular to a front surface of the circuit board.

5. The easy-to-assembly combined fan according to claim 4, wherein a body of the conductive needle is arranged with an insulating base, and the insulating base is embedded into the through hole of the second combination end.

6. The easy-to-assembly combined fan according to claim 1, wherein a first protrusion and a second protrusion are arranged at a periphery inside the annular limit groove corresponding to the through hole of the second combination end, the first protrusion abuts against a front surface of the circuit board, and the second protrusion abuts against a back surface of the circuit board.

7. The easy-to-assembly combined fan according to claim 1, wherein a third protrusion is arranged inside the annular limit groove corresponding to the first electrode, the third protrusion abuts against a back surface of the circuit board, and the first electrode is arranged at a front surface of the circuit board.

8. The easy-to-assembly combined fan according to claim 7, wherein the third protrusion comprises:
a plate-shaped portion attached on the back surface of the circuit board; and
a rib portion connected between a back surface of the plate-shaped portion and a groove wall of the annular limit groove.

9. The easy-to-assembly combined fan according to claim 1, wherein the first combination end and the second combination end are parallel.

10. An easy-to-assembly combined fan structure, comprising:
a frame, comprising an upper housing and a lower housing, wherein the upper housing and the lower housing enclose an annular limit groove;
a light strip, arranged inside the annular limit groove, wherein the light strip comprises a PCB and light bulbs, the light bulbs are arranged at the PCB with intervals, and the PCB is arranged with a transition portion cooperating with a bent end of the frame; and
an electrical connection part, welded on the PCB, wherein the electrical connection part is exposed to at least one combination surface of an outer wall of the frame.

11. The easy-to-assembly combined fan structure according to claim 10, wherein the PCB is a flexible PCB and is configured to be deformed and bent according to a shape of the annular limit groove.

12. The easy-to-assembly combined fan structure according to claim 10, wherein the bent end is arranged at a 45-degree inclination.

13. The easy-to-assembly combined fan structure according to claim 10, wherein the electrical connection part comprises an insulating boss and an electrode portion arranged at the insulating boss.

14. The easy-to-assembly combined fan structure according to claim 10, wherein the electrical connection part is arranged at a position of the transition portion.

15. The easy-to-assembly combined fan structure according to claim 13, wherein the electrode portion is an electrode sheet or an elastic center.
